(19) United States
(12) Patent Application Publication
(10) Pub. No.: US 2007/0154679 A1
(43) Pub. Date: Jul. 5, 2007

(54) Adhesive closing part

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/570,275

(22) PCT Filed: Jul. 23, 2004
(86) PCT No.: PCT/EP04/08215

§ 371 Date: Oct. 18, 2006

(30) Foreign Application Priority Data
Sep. 6, 2003 (DE) 103 41 151.8

(51) Int. Cl. B32B 3/06

(52) U.S. Cl. 428/99; 428/100; 428/900

(57) ABSTRACT

The invention relates to an adhesive closing part comprising a support band (10) that is provided with hooking elements (12) which are arranged thereupon, and a cover band (16) that covers the support band (10) on the side facing away from the hooking elements (12) and is wider than the support band (10) such that free lateral edge zones of the cover band (16) extend beyond the associated longitudinal edges of the support band (10) on both sides. The two free lateral edge zones are folded back in the direction of the rear face of the support band (10) so as to form one respective accommodating space (20) while being interconnected such that a tubular member (22) is formed at least by parts of the cover band (16), resulting in a reliably functioning sealing option for the hooking elements.

The invention relates to an adhesive closing part having a support strip with interlocking elements mounted on it and having a cover strip on the side facing away from the interlocking elements covering the support strip, the cover strip being wider than the support strip so that free side edge areas of the cover strip extend on both sides beyond the associated longitudinal edges of the support strip.

Adhesive fastener elements such as this are employed for a variety of purposes, such as in automotive technology, flooring technology, clothing of all kinds, and for special applications in mechanical engineering. Adhesive fastener elements have proved themselves to be reliable detachable connection and fastening elements in these fields. When such adhesive fastener elements are used for aircraft or motor vehicle passenger seats, they serve the purpose of fastening seat covers to foamed parts; some adhesive fastener elements are foamed into the foam upholstery material during production of the respective seat, while the adhesive fastener element with the corresponding interlocking elements is fastened to the cover upholstery material, in particular is sewn on. For the purpose of producing the foam body element the adhesive fastener elements are introduced into so-called seating pipes of a foam injection mold and, by introduction of foam material into the free cross-sections of the foam injection mold, preferably one of polyurethane (PU) foam, the adhesive fastener elements are fastened on the foam body elements in the foam injection process. The pipes employed normally project above the other walls of the foam injection mold and thus later form groove-like recesses in the foam body element which is then engaged in the upholstery cover material with the other corresponding adhesive fastener element. In this way geometric seam and shape patterns may be produced on a particular seat.

DE-A-199 56 011 discloses an adhesive fastener element for application for this purpose in the seating area, one having a support strip and interlocking elements mounted on the support strip; the support strip has at least one reinforcing element resistant to bending, one which extends preferably along the support strip in the form of a bending wire. Application of the solution disclosed results in better embedding properties in foam molds for adhesive fastener elements and, because of the flexural strength of the reinforcing element, once adhesive fastener elements have been introduced into the respective foam injection mold, they remain in their position. In the solution disclosed the cover strip is applied in one layer so as to be flush with the upper side of the foam injection mold, and so the possibility is not to be excluded that, during the foam injection process itself preferably involving polyurethane foam (PU), the latter may raise the cover strip above the side edges of the foam injection mold and so reach the interior of the duct-like injection mold in which the support strip with bending wire and the interlocking elements is seated. However, penetration of the intermediate areas of the interlocking elements by the foam weakens the fastening capability of these elements, so that they may not be effective when engaged with corresponding closing elements of the other component; this on the whole reduces the adherence of the disclosed adhesive fastener elements.

In order to offset this disadvantage DE-A-100 39 940 has already proposed for a generic adhesive fastener element a cover strip which is wider than the support strip. The two free side edge areas of the cover strip are each folded back themselves in the direction of the support strip along a fold line extending in the longitudinal direction, so that the end edges of the free side edge areas of the cover strip face the longitudinal edges of the support strip. As a result, the cover strip has on both sides a sort of sealing lip which always extends along the area having the interlocking elements and is adjacent to the wall elements of the foam injection mold which encloses the molding depression in which the interlocking elements are received during the foaming process. The foam material introduced into the foam injection mold causes this sealing lip to be pressed against the facing wall elements of the mold. As a result of the certain amount of flexibility in the area of the fold line, the sealing lip rests against the wall areas forming the sealing surface so that the improvement desired in the sealing action as foam barrier is achieved. In order then to impart a certain amount of flexural resistance to the adhesive fastener element, something which perceptibly improves handling during introduction into the foam injection mold, this disclosed solution also has a flexurally-resistant element in the form of a bending wire.

Unintentional penetration of foam material in the direction of the interlocking elements may occur even with these disclosed solutions despite this sealing lip configuration. It has been found in particular that the disclosed sealing solution encounters its limits where the foam injection mold has no molding depression (cost-intensive in production) for reception of the interlocking elements of the adhesive fastener element.

Since both of the disclosed solutions have recesses in the foam injection pipe to receive the interlocking elements, problems also arise in surface cleaning of the mold, since fouling matter may unintentionally settle there.

On the basis of this state of the art the object of the invention is further to improve the disclosed adhesive fastener elements so that, while their advantages are retained, they have an even better effect in sealing of the mold foam to be introduced into a foam injection mold and so that they may also be adapted to the geometric patterns of a specified foam injection mold having no mold depression or recess to receive the interlocking elements during the foam injection process. The object as thus described is attained by means of an adhesive fastener element having the characteristics specified in patent claim 1 in its entirety.

In that, as specified in the characterizing part of claim 1, the two free side edge areas are folded back so that a reception space is formed in each of the areas in the direction of the rear side of the support strip and so that the two areas are interconnected, with the result that a reliably functioning option is achieved for sealing the interlocking elements from the mold foam, and so that the respective sealing system may be reliably introduced by an operator by simple means into the associated foam injection mold. The adhesive fastener element claimed for the invention has been found to be advantageous for foam injection molds (foam injection pipes) the upper side of which is essentially level, and in particular extends horizontally when in the use position. In the respective molding tool configuration the interlocking elements may then be positioned on the upper side of the foam injection mold and nevertheless may be reliably sealed in the side edge area by way of the mounting indicated of the cover strip configured as a hose element. The adhesive fastener element in question is space-saving and cost-effective especially with respect to production technology. In addition, the production costs for the respective foam injection mold may be reduced, since this mold no longer need have the otherwise customary groove-like recesses for mounting the interlocking elements. Handling of the adhesive fastener element and its introduction into the foam injection mold are also facilitated for a person operating the foam injection device and cleaning is made easier by the smooth surface of the top of the foam injection mold.

The hose element indicated may consist exclusively of parts of the cover strip molded around the recesses, so that the cover strip is in the form of an annular element. It is also possible, however, to produce an open hose element, the free ends of the side edge areas being on the rear side of the support strip with the interlocking elements fastened on the cover strip layer between them, by means of a suitable adhesive, for example.

In another preferred embodiment of the adhesive fastener element claimed for the invention the cover strip is connected to the support strip by way of an adhesive; the parts of the cover strip which extend along the rear side of the support strip facing away from the interlocking elements are also joined to each other by an adhesive. Durable interlocking of the individual layers of the adhesive fastener element is thereby achieved.

In another especially preferred embodiment of the adhesive fastener element claimed for the invention the cover strip, the support strip, the interlocking elements, and/or the adhesive at least to some extent possess ferromagnetic properties, so that the adhesive fastener element may be held in place on the foam injection mold by means of a magnetic retaining unit such as one in the form of permanent magnet strips in the foam injection mold or in the so-called seating pipe of the foam injection mold, such strips being embedded in the strip-like adhesive fastener element when the latter is aligned.

In order to impart a certain amount of bending resistance to the adhesive fastener element, something which definitely facilitates handling of the adhesive fastener element when it is introduced into the foam injection mold or the foam injection pipe, especially if specified lengths of the adhesive fastener element are to be introduced into the respective foam injection mold in complex three-dimensional structures, in one preferred embodiment of the adhesive fastener element claimed for the invention provision is made such that there is introduced into the respective reception space inside the hose element a bending wire which possesses ferromagnetic properties and accordingly is a component of the ferromagnetic fastening system. Consequently, as a result of use of the ferromagnetic stiffening wire along both longitudinal edges of the hose element which form the receptacle, fixing of the adhesive fastener element in place on the foam injection mold is effected and the system claimed for the invention for sealing the interlocking elements from the mold foam is created.

The interlocking elements of the adhesive fastener element claimed for the invention may be in the form of stalk-shaped, hooked, looped, fleece-like, or mushroom-shaped adhesive fastener elements.

One embodiment of the adhesive fastener element claimed for the invention will be described in detail below with reference to the drawing, in which, in the form of diagrams not drawn to scale,

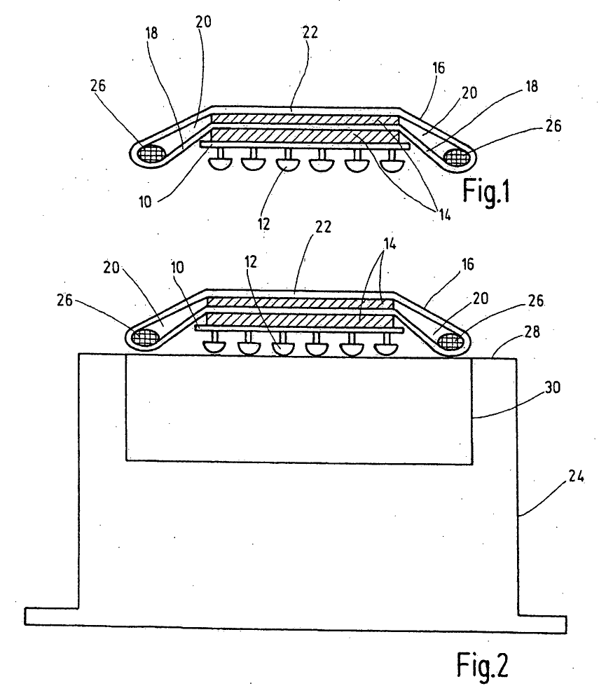

FIG. 1 presents a front view of the adhesive fastener element claimed for the invention;

FIG. 2 a front view of a part of a foam injection mold (foam injection pipe) with adhesive fastener element positioned on it as shown in FIG. 1 in the use position.

The adhesive fastener element claimed for the invention has a support strip 10. Interlocking elements 12 mounted side by side and one behind the other are present on one side of the support strip 10. For example, the adhesive fastener element may be a so-called microfastener in which 200 to 400 interlocking elements per square centimeter are provided on a support strip 10 of a thickness of 0.1 mm to 0.3 mm. An exemplary process for production of the support strip 10 of such a microfastener is disclosed in DE-C-198 28 856. In this disclosed process a thermoplastic material is introduced by means of an extrusion tool into the gap between a pressure tool and a molding tool, a sieve having through openings is used as shaping element, and the interlocking elements being in the form of plastic setting at least to some extent in the holes in the sieve. In addition to the sieve molding process indicated, a different extrusion or casting process may be applied for production of the support strip 10 with interlocking elements 12.

As is also to be seen from the figures, an adhesive is applied to the rear side of the support strip 10; this laminar adhesive means 14 may consist, for example, of a moisture-crosslinking polyurethane (PU) but may also be an acrylate adhesive or other suitable adhesive means. The adhesive means 14 essentially covers one side of the support strip 10 and is rigidly connected to it. A cover strip 16 is rigidly connected to the support strip 10 by way of the laminar adhesive means 14 indicated. The pertinent cover strip 16 is designed to be wider than the support strip 10 so that the free side edge areas 18 of the cover strip 26 extend on both sides beyond the associated longitudinal edges of the support strip 10. In addition, the two free side edge areas 18 are folded back in the direction of the rear side of the support strip 10, each forming a reception space 20 in the direction of the rear side of the support strip 10, the free side edge areas 18 being interconnected toward the rear so that a hose element 22 is formed at least by parts of the cover strip.

In the present embodiment the hose element 22 is closed on itself and accordingly forms an annular element, the parts of the cover strip 16 which extend over the rear side of the support strip 10 facing away from the interlocking elements 12 also being interconnected by an adhesive means 14. What is thereby obtained on the rear side is a stack made up in sequence of adhesive means 14, parts of the cover strip 16, additional adhesive means 14, and other parts of the cover strip 16. The width of the cover strip employed may be specified as determined by requirements and its configuration is based on the cross-sectional shapes, and especially the widths, of the respective foam injection pipe 24 as form mold element (see FIG. 2).

The cover strip 16 may consist of a textile material, a non-woven fabric, or a plastic fabric, preferably one with open pores, in order to achieve good adhesion of the foam to the cover strip. Reliable bonding of the adhesive fastener element to the molded foam element (not shown) is thereby obtained; the interlocking elements 12 are in any event available for engagement free of foam with corresponding elements of another adhesive fastener element. A bending wire 26 possessing ferromagnetic properties is integrated into both sides of the pocket-shaped recesses 20. This bending wire could however, also be replaced in the recess 20 by a medium not shown (powdered iron or the like) also possessing ferromagnetic properties. The respective configuration of an adhesive fastener element is essentially resistant to bending because of the bending wire feature but is otherwise entirely flexible with regard to the other components employed and may be bent in its longitudinal direction and accordingly also forward and backward.

The illustration in FIG. 2 relates to use of an adhesive fastener element as shown in FIG. 1. Part of the foam injection mold as molding tool, also referred to in technical language as foam injection pipe 24, is shown in cross-section in FIG. 2. The respective foam injection pipe 24 has a level bottom surface or upper side, there being introduced into this bottom element of the foam injection pipe 24 a bar-shaped magnet element 30 which operates in conjunction with the corresponding components of the adhesive fastener element shown in FIG. 1. In addition to use of the pair of bending wires 26 provision may be made such that the cover strip 16 and/or the support strip 10 and/or the interlocking elements 12 and/or the adhesive means 14 at least to some extent possess ferromagnetic properties. The iron particles used for this purpose by preference may be integrated into the respective element of the adhesive fastener element and/or may be applied to the respective component in the form of a coating. In addition, a ferromagnetic powder may be applied in the form of a coating paste. Depending on the components of the adhesive fastener element which undergo ferromagnetic treatment as described, however, preferably full-surface contact with the magnet element 30 of the foam injection pipe 24 is obtained.

As the illustration of FIG. 2 also shows, the adhesive fastener element claimed for the invention as described in the foregoing is applied so that the two side edge areas extend at an angle of approximately 30° to 45° downward in the direction of the interlocking elements 12 and are held in position by the magnetic force between magnetic element 30 and associated bending wire 26. This results in a beaded sealing lip formed by deflection of the cover strip in the area of the two reception spaces 20. This sealing lip exerts a high sealing force which prevents the foam material entering the foam injection mold from advancing in the direction of the interlocking elements 12. The geometric size selected for the hose element 22 is such that the free ends of the interlocking elements 12 are always reliably covered. Since the elements of the cover strip 16 are oriented in the direction of the respective laminar adhesive means 14 so as to move toward each other in the form of a gap and spaced at a distance from each other, a favorable introduction of force is exerted on the bending wires 26 by the magnetic force. This force presses the stack package as a whole, including the support strip 10 with interlocking elements 12, in the direction of the foam injection pipe 24, so that sealing on the edges is achieved by way of the interlocking elements.

The adhesive fastener element claimed for the invention is especially well suited for aircraft or motor vehicle passenger seats. It serves the purpose of fastening seat covers on foam elements; adhesive fastener elements are foamed into the foam upholstery material in production of a particular seat and the adhesive fastener element is fastened on the upholstery cover material with the corresponding interlocking elements. Individual pot-like or strip-like magnetic elements may be introduced into the foam injection pipe 24 in place of the full-surface magnet element configuration 30 shown in FIG. 2. However, in order to ensure a reliable sealing effect it is important for the bending wire 26 or other ferromagnetic medium of the reception space 20 to be attracted by the foam injection mold 24 by magnetic means.

1. An adhesive closing part having a support strip (10) with interlocking elements (12) mounted on it and having a cover strip (16) on the side facing away from the interlocking elements (12) covering the support strip, the cover strip (16) being wider than the support strip (10) so that free side edge areas (18) of the cover strip (16) extend on both sides beyond the associated longitudinal edges of the support strip (10), characterized in that the two free side edge areas (18) are folded back so that a reception space (20) is formed in each of the areas in the direction of the support strip (10) and the two areas are interconnected so that a hose element (22) is formed at least by parts of the cover strip (16).

2. The adhesive fastener element as claimed in claim 1, wherein the hose element (22) formed by the cover strip (16) configures a closed annular element.

3. The adhesive fastener element as claimed in claim 1, wherein the cover strip (16) is joined to the support strip (10) by adhesive means (14) and wherein the parts of the cover strip (16) which extend over the rear side of the support strip (10) facing away from the interlocking elements (12) are also joined to each other by way of adhesive means (14).

4. The adhesive fastener element as claimed in claim 1, wherein the cover strip (16) consists of a textile material, a non-woven material, or a plastic fabric, and wherein the interlocking elements (12) are in the form of polyamide or polypropylene.

5. The adhesive fastener element as claimed in claim 1, wherein the support strip (10) with interlocking elements (12) is produced by an extrusion or molding process.

6. The adhesive fastener element as claimed in claim 1, wherein the cover strip (16), the support strip (10), the interlocking elements (12), and/or the adhesive means (14) possess ferromagnetic properties.

7. The adhesive fastener element as claimed in claim 1, wherein the respective reception space (20) inside the hose element (22) serves the purpose of receiving a medium which possesses ferromagnetic properties.

8. The adhesive fastener element as claimed in claim 7, wherein the medium is in the form of a bending wire (26) which is introduced into each of the pocket-like recesses (20) of the hose element (22).

9. Application of an adhesive fastener element as claimed in claim 1, characterized in that such adhesive fastener element may be positioned mounted on a foam injection tool (24) which extends horizontally on its upper side (28) facing the adhesive fastener element, and in that the hose element (22) is in contact sealing the interlocking elements (12) with this upper side (28) by way of its reception spaces (20).
